(19) United States
(12) Patent Application Publication
(10) Pub. No.: US 2006/0213307 A1
(43) Pub. Date: Sep. 28, 2006

(54) Power transmission device for driving robot wrist and power transmission device

(75) Inventors: Takashi Haga, Ohbu-shi (JP); Yo Tsurumi, Chiryu-shi (JP); Jun Tamenaga, Ohbu-shi (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: SUMITOMO HEAVY INDUSTRIES, LTD.

(21) Appl. No.: 11/377,873

(22) Filed: Mar. 17, 2006

(30) Foreign Application Priority Data
Mar. 24, 2005 (JP) 2005-086971

(51) Int. Cl. B25J 18/00

(52) U.S. Cl. 74/490.01

(57) ABSTRACT

The power transmission device includes an internal gear and an external gear that is inscribed in the internal gear and engages with the internal gear, and can transmit an input power to an attachment. The power transmission device further includes: an inner pin for bringing out a relative rotation component between the internal gear and the external gear; and an output flange connected to the inner pin. In this configuration, the inner pin and the output flange are integrally formed as one member, and a mounting hole for connecting the output flange to the attachment is formed in a surface of the output flange that is opposite to the inner pin.

### BACKGROUND OF THE INVENTION

1. Field of the Invention

The present invention relates to a power transmission device. More particularly, the present invention relates to a power transmission device capable of transmitting an input power to a next-stage member (including an attachment), which can be suitably used for driving a robot wrist.

2. Description of the Related Art

A power transmission device disclosed in Japanese Patent Laid-Open Publication No. 2002-61720 is conventionally known. This power transmission device has an output shaft in the shape of a flange and can be directly attached to a next-stage member (e.g., an attachment of an industrial robot).

FIGS. 4A, 4B, and 4C show a power transmission device 290 having approximately the same structure as the aforementioned conventional power transmission device disclosed in Japanese Patent Laid-Open Publication No. 2002-61720. FIG. 4A is a front view of the power transmission device 290, FIG. 4B is a cross-sectional view thereof, taken along the line IVB-IVB in FIG. 4A, and FIG. 4C is a rear view thereof.

The power transmission device 290 includes an input shaft 260, an eccentric body 240 that is rotated in an eccentric manner by rotation of the input shaft 260, a bearing 230 for the eccentric body that transmits the eccentric rotation of the eccentric body 240, an external gear 238 that is fitted with the bearing 230, and an internal gear 234 in which the external gear 238 is inscribed. The internal gear 234 and the external gear 238 engage with each other. There is a small difference between the number of teeth of the internal gear 234 and that of the external gear 238. The internal gear 234 also serves as a casing 250.

The external gear 238 has a plurality of inner pin holes 238a. An inner pin 236 and an inner roller 232 are freely inserted into each of the inner pin holes 238a.

The inner pin 236 is fitted into a first output flange 200 and a second output flange 202. The first output flange 200 and the second output flange 202 are connected to each other via a carrier bolt 228.

The reference numeral 270 in FIG. 4A denotes a mounting hole used for mounting an attachment (not shown) of a robot onto the power transmission device 290.

When the input shaft 260 rotates around a shaft center O4, the eccentric body 240 provided on an outer circumference of the input shaft 260 also rotates. The rotation of the eccentric body 240 tries to cause oscillating rotation of the external gear 238 around the input shaft 260. However, the rotation of the external gear 238 is constrained by the internal gear 234. Therefore, the external gear 238 makes an oscillating movement almost only, while being in contact with the internal gear 234.

The oscillating movement component of the oscillating rotation of the external gear 238 is absorbed by the inner pin hole 238a and the inner pin 236 (and the inner roller 232). Only the rotation component generated by the difference between the number of teeth of the external gear 238 and that of the internal gear 234 is transmitted to the attachment via the first output flange 200.

When the above-described power transmission device is used especially in an industrial robot, a next-stage member such as an attachment to be mounted onto the power transmission device (hereinafter, simply referred to as an attachment or the like) is inevitably different depending on the purpose of the industrial robot, e.g., welding, transport, or assembly. Thus, the power transmission device should be able to transmit a power to various types of attachment or the like.

Therefore, when a mounting hole (e.g., a tap) is formed in the output flange of the power transmission device and the attachment or the like is mounted by means of a mounting screw or the like, if another member (e.g., the inner pin or the carrier bolt) is fitted into the output flange, it is inevitably necessary to form the mounting hole at a position other than a position of the other member. Thus, the position of the mounting hole and the number of mounting holes that can be formed are limited (see FIG. 4A).

In other words, for some types of attachment or the like to be mounted, the mounting hole cannot be formed while sufficient mounting strength is ensured. Thus, in some cases, it is necessary to use a separate joint flange for connection, or a problem is caused that the power transmission device or a mounting portion of the attachment or the like to be mounted has to be redesigned.

### SUMMARY OF THE INVENTION

In view of the foregoing problems, various exemplary embodiments of this invention provide a power transmission device including an output flange that has a high degree of freedom of design for a mounting hole used for attaching an attachment or the like to the power transmission device, thereby allowing a wider variety of attachment or the like to be directly attached to the power transmission device without using a separate joint flange or redesigning the power transmission device and the like.

Various exemplary embodiments of the present invention provide a power transmission device for driving a robot wrist. The power transmission device includes an internal gear and an external gear that is inscribed in the internal gear and engages with the internal gear, and can transmit an input power to an attachment. The power transmission device further includes: an inner pin for bringing out a relative rotation component between the internal gear and the external gear; and an output flange connected to the inner pin. In this configuration, the inner pin and the output flange are integrally formed as one member, and a mounting hole for connecting the output flange to the attachment is formed in a surface of the output flange that is opposite to the inner pin.

According to various exemplary embodiments of the invention, the inner pin and the output flange are integrally formed. Thus, it is possible to avoid a problem in which the mounting hole for attaching the attachment or the like has to be designed at a position other than a position of the inner pin. Therefore, the mounting hole for attaching the attachment or the like can be designed more freely.

The present invention can be applied to a reducer in which the inner pin is supported at both ends. Moreover, the present invention can be applied to a reducer in which the inner pin projects from the output flange while being supported at one end, as in the aforementioned example, as well as an exemplary embodiment described later. Incidentally, in the reducer in which the inner pin is supported at both ends, the use of a carrier bolt is not denied. However, the inner pin according to various exemplary embodiments of the present invention is integrated with the output flange and has strength that is sufficient to serve as the carrier bolt. Thus, an operation of the present invention can be more significantly achieved by completely eliminating the carrier bolt and making all the pins serve as inner pins.

In this description, a side closer to a working portion (attachment) in an industrial robot is referred to as a “next stage.”

According to various exemplary embodiments of the present invention, it is unnecessary to use a separate joint flange in accordance with the attachment or the like or change design of the power transmission device and the like. Furthermore, the power transmission device that is compact, has a good balance of rotation, and has high strength can be designed.

### BRIEF DESCRIPTION OF THE DRAWINGS

FIG. 1 is a partial cross-sectional view of a whole power transmission device 190 attached to a robot wrist according to an exemplary embodiment of the present invention;

FIGS. 2A and 2B show the whole power transmission device according to the exemplary embodiment of the present invention,

FIG. 2A being a front view thereof, and FIG. 2B being a cross-sectional view thereof, taken along the line IIB-IIB in FIG. 2A;

FIGS. 3A and 3B show the power transmission device shown in FIGS. 2A and 2B in which a mounting hole for a next-stage member is provided, FIG. 3A being a front view thereof, and FIG. 3B being a cross-sectional view thereof, taken along the line IIIB-IIIB in FIG. 3A; and

FIGS. 4A, 4B, and 4C show a whole power transmission device of a conventional example, FIG. 4A being a front view thereof, FIG. 4B being a cross-sectional view thereof, taken along the line IVB-IVB in FIG. 4A, and FIG. 4C being a rear view thereof.

### DETAILED DESCRIPTION OF THE PREFERRED EMBODIMENTS

An exemplary embodiment of the present invention is now described with reference to the accompanying drawings. In the description and the drawings, components that are the same or similar as/to those in the aforementioned conventional example are labeled with reference numerals in which last two digits are the same as those in the conventional example, and the description of those components is omitted in an appropriate manner. That is, only a difference between the exemplary embodiments of the present invention and the conventional example is described.

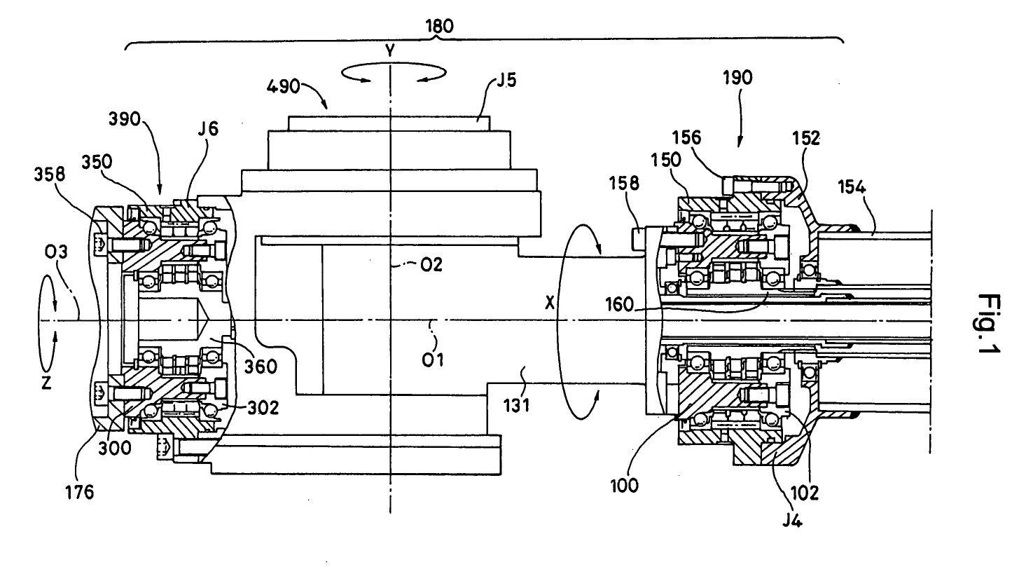

FIG. 1 is a partial cross-sectional view showing a whole power transmission device according to an exemplary embodiment of the present invention. The power transmission device is attached to a robot wrist. In the following description, the robot wrist means a portion including the fourth one of a plurality of axes included in a robot and all the following portions. More specifically, the robot wrist means a portion including an arm portion of the robot formed by basic three axes, i.e., a pivot axis, a back-and-forth axis, and a vertical axis and the following portion (a portion arranged more closely to the attachment).

A wrist including three joints J4, J5, and J6 is provided in a robot arm 154 extended from the arm portion. An attachment 176 is attached to an end of the robot arm 154. FIG. 1 only shows a part of the attachment 176. Although three joints are provided in the wrist in the present exemplary embodiment, the number of the joints is not limited thereto. Four or more, or two or less, joints may form the wrist. Each of those joints J4, J5, and J6 includes a power transmission device. More specifically, the joint J4 includes a power transmission device 190, the joint J5 includes a power transmission device 490 (FIG. 1 only shows an appearance thereof), and the joint J6 includes a power transmission device 390. The joint J4 is arranged to be rotatable in an X-direction around a shaft center O1, the joint J5 is arranged to be rotatable in a Y-direction around a shaft center O2, and the joint J6 is arranged to be rotatable in a Z-direction around a shaft center O3. According to this structure, cooperating rotation of those joints J4, J5, and J6 enables the attachment 176 to be freely manipulated three-dimensionally.

The power transmission devices 190, 390, and 490 respectively included in the joints J4, J5, and J6 have the same structure basically, although they are different in detail.

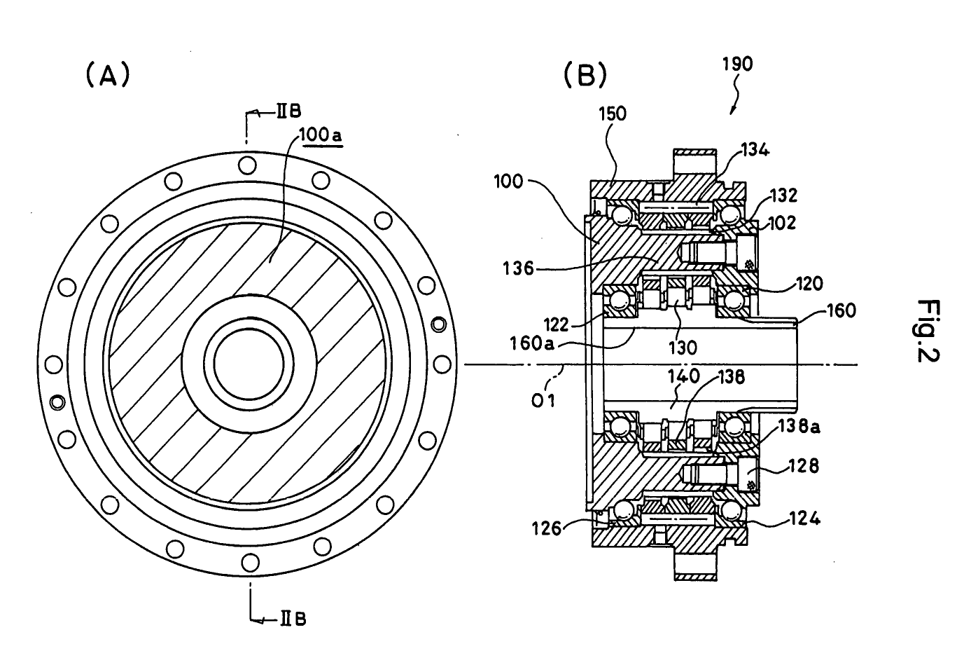

Next, the power transmission device 190 will be described as a representative of the power transmission devices 190, 390, and 490 with reference to FIGS. 2A and 2B. The other power transmission devices 390 and 490 have approximately the same structure as the power transmission device 190. Therefore, the same or similar components in the power transmission devices 390 and 490 as/to those in the power transmission device 190 are labeled with reference numerals that are the same in last two digits as those in the power transmission device 190, and redundant description is omitted. FIGS. 2A and 2B show the whole power transmission device 190. FIG. 2A is a front view thereof, and FIG. 2B is a cross-sectional view thereof, taken along the line IIB-IIB.

In the present exemplary embodiment, an inner pin 136 and a first output flange (output flange) 100 are integrally formed as one member. Herein, the phrase “be integrally formed as one member” does not mean that a plurality of parts are integrated by fixing them by press fitting, adhesion, or the like but means that they are originally formed with integrity by forging or the like.

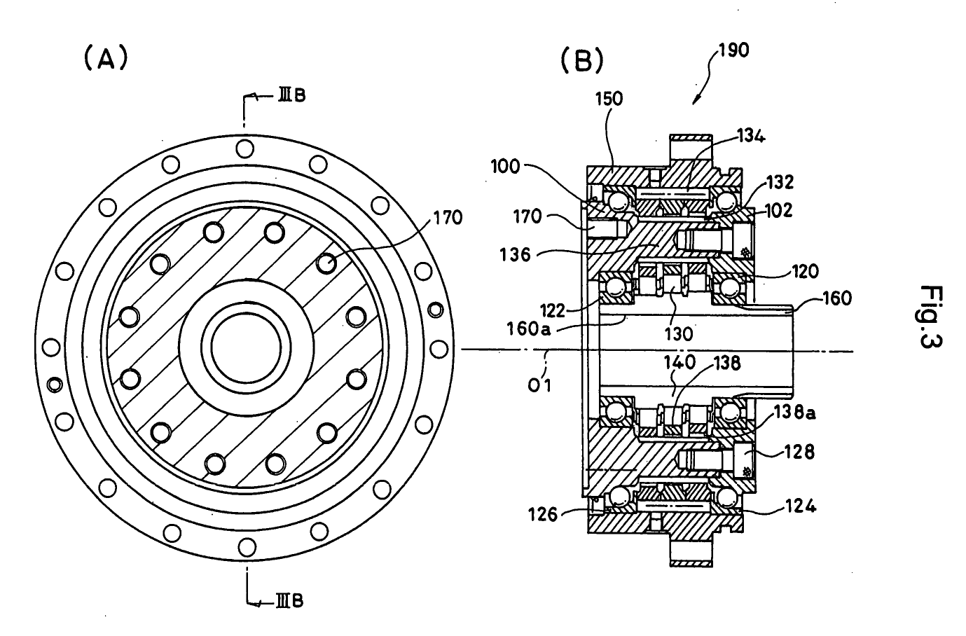

The first output flange 100 integrally formed with the inner pin 136 is connected and fixed to a second output flange 102 (second output flange) via the inner pin 136 by means of a bolt 128 screwed from a side of the second output flange 102 that is opposite to the inner pin 136. No carrier bolt is used in this arrangement. A first output flange surface 100a is secured on the first output flange 100 on a side opposite to the inner pin 136, as shown with hatching in FIG. 2A. The first output flange surface 100a has nothing formed thereon and is flat. Therefore, a mounting hole can be freely formed in the first output flange surface 100a in advance or in accordance with a hole position in a next-stage member 131 later. FIGS. 3A and 3B show an example of formation of an exemplary mounting hole 170.

An operation of the present exemplary embodiment will now be described. In the following, redundant description is omitted and only a difference between the present exemplary embodiment and the conventional example is described.

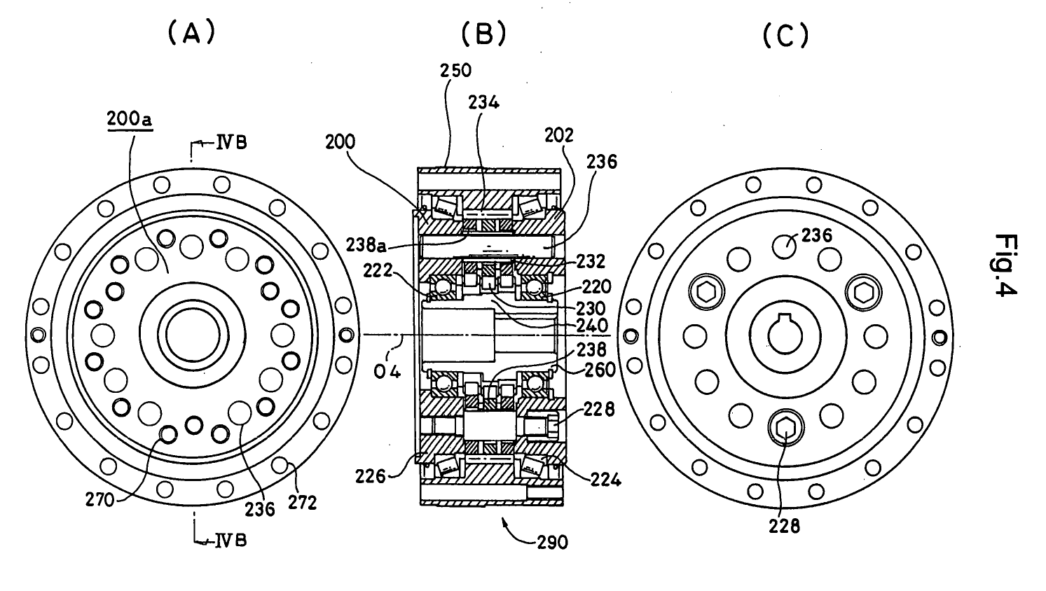

Since the inner pin 136 for transmitting a rotation component of an external gear 138 is formed integrally with the first output flange 100, the first output flange surface 100a is secured on the side of the first output flange 100 that is close to the next-stage member 131 (i.e., on the side opposite to the inner pin 136) as shown with hatching (see FIG. 2A). In the exemplary embodiment shown in FIGS. 3A and 3B, screw holes 170 are formed in the first output flange surface 100a at similar positions to those in FIG. 4A for the sake of convenience. However, the position at which the screw hole 170 is formed is not limited thereto, as is apparent from comparison between FIG. 3A and FIG. 4A. This is because an end face of the inner pin 236 or the carrier bolt 228 that was conventionally located on the first output flange surface 100a is not located on the first output flange surface 100a in the present exemplary embodiment.

Therefore, even if the next-stage member is changed, there are few needs of using a separate joint flange or changing design of the power transmission device in accordance with the next-stage member.

Especially, in the case of a power transmission device attached and used in a wrist of an industrial robot, it is preferable to make the power transmission device as light and small as possible in order to precisely control the robot (position the robot), secure a wide work range, and save an electric power.

Therefore, it is highly significant that the degree of freedom of determining the position at which the mounting hole 170 is processed is improved without increasing the weight or the like, as in the present exemplary embodiment.

Moreover, in the present exemplary embodiment, the first output flange 100 and the second output flange 102 are connected to each other by means of the inner pin 136 only without using a carrier bolt conventionally used. However, the first output flange is integrated with the inner pin 136 and the second output flange is tightly connected to the first output flange by means of the bolt 128. Therefore, each of the inner pins 136 can sufficiently fulfill a connecting function of the carrier bolt conventionally used.

In addition, all the inner pins 136 can contribute to power transmission. Therefore, a load applied to each inner pin 136 is reduced because the inner pin 136 is also arranged at a position at which the carrier bolt is conventionally arranged.

Furthermore, the inner pin 136 and the bolt 128 are arranged evenly in a radial direction. Therefore, the power transmission device that has a good balance of rotation during an operation can be achieved.

In the present exemplary embodiment, a top end of the inner pin 136 is supported by the second output flange 102. Alternatively, another arrangement may be employed in which the second output flange is omitted and the inner pin 136 projects from the first output flange 100 while being supported at one end. That is, the arrangement around the top end of the inner pin 136 (the side close to the second output flange in the above exemplary embodiment) is not specifically limited.

Moreover, the external gear is formed of three pieces in the present exemplary embodiment. However, the structure of the external gear is not necessarily limited thereto. The number of pieces forming the external gear may be selected in accordance with a transmission capacity (e.g., one or two).

The most significant effect of the present invention can be achieved when the present invention is applied to a power transmission device attached to a wrist of an industrial robot, as described in the exemplary embodiment. A servomotor may be connected with the power transmission device. However, it is apparent that the present invention can be also applied to another type of power transmission device for transmitting a power to another machine.

The disclosure of Japanese Patent Application No. 2005-86971 filed Mar. 24, 2005 including specification, drawing and claim are incorporated herein by reference in its entirety.

What is claimed is:

1. A power transmission device for transmitting an input power to an attachment to drive a robot wrist, the device comprising:
an internal gear;
an external gear that is inscribed in the internal gear and engages with the internal gear;
an inner pin bringing out a relative rotation component between the internal gear and the external gear; and
an output flange connected to the inner pin, wherein
the inner pin and the output flange are integrally formed as one member, and
a mounting hole for connecting the output flange to the attachment is formed in a surface of the output flange that is opposite to the inner pin.

2. The power transmission device according to claim 1, further comprising a second output flange provided on an opposite side of the external gear to the output flange, wherein
the output flange and the second output flange are connected to each other by means of the inner pin only.

3. A power transmission device for transmitting an input power to a next-stage member to drive a robot wrist, the device comprising:
an internal gear;
an external gear that is inscribed in the internal gear and engages with the internal gear;
an inner pin bringing out a relative rotation component between the internal gear and the external gear; and
an output flange connected to the inner pin, wherein
the inner pin and the output flange are integrally formed as one member, and
a mounting hole for connecting the output flange to the next-stage member is formed in a surface of the output flange that is opposite to the inner pin.

4. The power transmission device according to claim 3, further comprising a second output flange provided on an opposite side of the external gear to the output flange, wherein
the output flange and the second output flange are connected to each other by means of the inner pin only.

5. A power transmission device capable of transmitting an input power to a next-stage member, comprising:
an internal gear;
an external gear that is inscribed in the internal gear and engage with the internal gear;
an inner pin for bringing out a relative rotation component between the internal gear and the external gear; and
an output flange connected to the inner pin, wherein
the inner pin and the output flange are integrally formed as one member, and
a mounting hole for connecting the output flange to the next-stage member is formed in a surface of the output flange that is opposite to the inner pin.

6. The power transmission device according to claim 4, further comprising a second output flange provided on an opposite side of the external gear to the output flange, wherein
the output flange and the second output flange are connected to each other by means of the inner pin only.
